(19) United States
(12) Patent Application Publication
(10) Pub. No.: US 2008/0285693 A1
(43) Pub. Date: Nov. 20, 2008

(54) RECEIVER APPARATUS FOR PROCESSING AMPLITUDE-MODULATED SIGNAL

(75) Inventors: Wei-Ting Wang, Yilan County (TW); Yih-Ming Tsuie, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/750,367

(22) Filed: May 18, 2007

(51) Int. Cl. H04L 7/00

(52) U.S. Cl. 375/355; 375/E07.01

(57) ABSTRACT

An amplitude-modulation signal reception apparatus is provided. The amplitude-modulation signal receiver apparatus includes a timing recovery module, a symbol phase shift unit, and an equalizer. The carrier recovery module removes a frequency offset and a phase jitter from an amplitude-modulation signal to generate a carrier recovered signal. The timing recovery module estimates a proper re-sampling position to re-sample the carrier-recovered signal. The phase shifter further shifts the signal that is timing recovered and carrier recovered. The equalizer applies equalization to the shifted signal to remove inter-symbol interference from the shifted signal.

### BACKGROUND OF THE INVENTION

### Field of the Invention

The invention relates to systems for recovering digitally modulated signals, and, more particularly, to a Vestigial Side Band (VSB) receiver system for recovering VSB modulated signals.

To compensate the effects of a band-limited transmission channel, many digital data communication systems employ an equalizer to remove intersymbol interference (ISI) in the received signal. ISI causes the value of a given symbol to be distorted by the values of preceding and succeeding symbols, and essentially represents symbol “ghosts.” If ISI is not effectively removed, receiver systems may not be able to provide high quality output or even fail to provide meaningful output.

An equalizer plays a critical role in reception performance. It is common for equalizer cost to be as much as 50% recourse of a demodulator. Thus, a more robust equalizer consuming less power is a subject of great interest.

### BRIEF SUMMARY OF THE INVENTION

In one embodiment, a receiver apparatus is provided for processing a received symbol stream that is amplitude-modulated. The receiver apparatus contains a synchronization module, a phase shifter and an equalizer.

The synchronization module removes carrier disorder like frequency offset and/or phase jitter from the received symbol stream. Also, the synchronization module estimates a re-sampling position of the received symbol stream for generating a compensated symbol stream according to the re-sampling position. The phase shifter adjusts the compensated symbol stream with a timing shift amount and a carrier shift amount to generate a shifted symbol stream. And, the equalizer equalizes the shift symbol stream.

With such design, the timing recovery and carrier recovery can be further adjusted for different situation so as to provide a better signal source to be equalized. For example, a controller is designed for providing different timing recovery shift amounts and/or carrier recovery shift amounts according to different input channel profiles.

According to another embodiment of the invention, receiver apparatuses similar to above are equipped with only timing recovery adjustment or carrier recovery adjustment. It is not necessary to have both timing recovery and carrier recovery.

### BRIEF DESCRIPTION OF THE DRAWINGS

The invention will become more fully understood from the detailed description, given herein below, and the accompanying drawings. The drawings and description are provided for purposes of illustration only, and, thus, are not intended to be limiting of the invention.

FIG. 1 shows an exemplary block diagram of an amplitude-modulation signal receiver apparatus;

FIG. 2 shows an amplitude-modulation signal receiver apparatus wherein the shift amount is determined by an equalization result;

FIG. 3 shows another exemplary block diagram of an amplitude-modulation signal receiver apparatus;

FIG. 4 shows an amplitude-modulation signal receiver apparatus wherein the carrier phase shift amount is determined by an equalization result;

FIG. 5 shows another exemplary block diagram of an amplitude-modulation signal receiver apparatus; and

FIG. 6 shows another amplitude-modulation signal receiver apparatus wherein the carrier phase shift amount is determined by an equalization result.

### DETAILED DESCRIPTION OF THE INVENTION

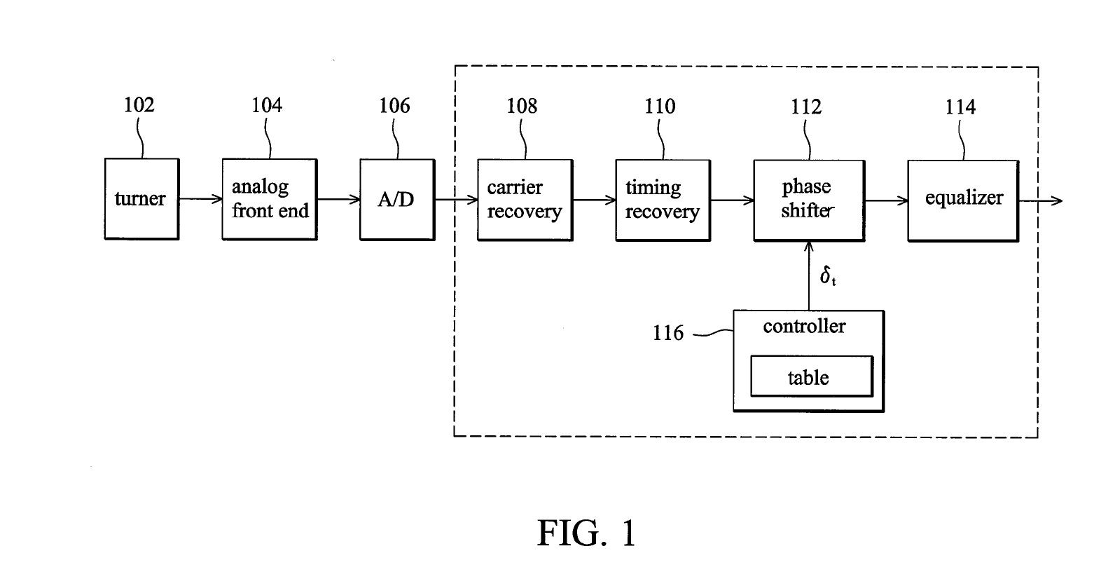

FIG. 1 is a diagram illustrating an exemplary receiver for receiving an amplitude-modulation signal, e.g. an Advanced Television Systems Committee (ATSC) television or an ATSC circuit board or an ATSC chip or other types of receivers for receiving and processing amplitude modulated signals. In this example, the receiver contains a tuner 102, an analog front end 104, and analog-to-digital (A/D) converter 106 for receiving a wireless signal and generating a corresponding digital stream. The tuner 102 selects an amplitude-modulation signal from a frequency band. The analog front end 104 receives an input spectrum from an intermediate frequency. The input spectrum includes an inserted pilot signal (as known as “carrier”), representing a pre-determined frequency component. The analog-to-digital converter (A/D) 106 digitizes the selected amplitude-modulation signal to generate the digital stream.

The digital stream is then supplied to a carrier recovery device 108 for removing a carrier frequency disorder, e.g. frequency offset and/or a phase jitter, from the digitized stream to generate a carrier recovered stream. A timing recovery device 110 estimates a re-sampling position of the carrier recovered stream and re-samples the carrier recovered stream for generating a re-sampled symbol stream based on the estimated re-sampling position. The term “device” recited here is not used for limiting the timing recovery device 110 and the carrier recovery device 108 only to two separate circuits. Instead, the timing recovery device and the carrier recovery device, which are used as a synchronization module, may be implemented in the same circuit or in the same chip that performs both time recovery and carrier recovery. For example, a processor, e.g. a digital signal processor (DSP), accompanied with two sets of instruction codes while one set is used for performing timing recovery and another set is used for performing carrier recovery. Moreover, the order of the timing recovery device 110 and the carrier recovery device 108 may be exchanged in an alternative design. That is, the timing recovery device 110 may be placed before the carrier recovery device 108. In the example of FIG. 1, the receiver contains both carrier recovery device 108 and the timing recovery device 110, but this is not necessary for every applications. For example, in base band application, it is usually not necessary to dispose the carrier recovery device 108. In other applications, a receiver may only need a timing recovery device.

Various known techniques may be applied to implement the carrier recovery and timing recovery. Due to pre-echo, post echo of the carrier and the ISI, however, a carrier and timing recovered signal is found not always the optimal signal for equalization. In this receiver, as an embodiment according to the invention, therefore, further adjustment is applied on the carrier and the timing recovered signal.

Following the timing recovery device 110 is therefore added a phase shifter 112 which further shifts the re-sampled stream with a timing shift amount and a carrier shift amount to generate a shifted symbol stream. The shifted symbol stream is then supplied to an equalizer 114 which equalizes the shift symbol stream. In this example, a controller 116 supplies the timing shift amount and the carrier shift amount to the phase shifter 112 to perform the further shifting, which is preferably a minor adjustments after the carrier recovery device 108 and the timing recovery device 110. The timing shift amount and the carrier shift amount may be predetermined as constant values when the receiver is produced, e.g. burning these predetermined values in an integrated circuit or writing these values to a flash memory or a ROM (Read Only Memory) that is accessible by the phase shifter 112. Alternatively, the timing shift amount and the carrier shift amount are dynamically adjustable and changed by the controller 116 as illustrated in FIG. 1. To determine proper values of the timing shift amount and the carrier shift amount, the receiver may further contain a channel estimator (not illustrated) for rendering a channel profile of the received amplitude modulated signal. A typical channel profile indicates strength and relative position between a main channel path and one or more than one cursor channel paths. For different channel profile, the controller 116 may refer to a table that stores different values of the timing shift amount and the carrier shift amount corresponding to different channel profiles. When the channel estimator figures out a corresponding channel profile of the digital stream, the controller 116 finds an item in the table that is most matched with the figured channel profile. Then, corresponding values of timing recovery amount and carrier recovery amount are transmitted to the phase shifter 112. Alternatively, the table may be implemented with equivalent logical conditions written in program codes or corresponding digital circuits. One or more formulas may also be incorporated in the controller 116 when finding it is necessary for handling certain signal input.

In FIG. 1, the shift amount δₜ is transmitted from the controller 116 to the phase shifter 112. To determine the value δₜ, the controller 116 may look up a table that is stored in a storage, e.g. a memory or a disk or some circuits. The table, for example, may comprise a channel profile type and an associated shift amount associated with the channel profile. Table 1 is an example. In the example, the left column lists various channel profile types that are obtained during experiments. In other words, even with a generalized timing recovery and/or carrier recovery formulas for all types of received signals, the phase shifter 112 may still be able to fine tune the compensation results after the synchronization module. The term “synchronization module” used here refer to pre-processing before data are input to the equalizer 114. The shift amount value is configurable, even after manufacture of the reception apparatus. For example, the default shift amount may be 1.15°. A receiver product shipped to a certain area may be with the shift amount to 1.13°, while the receiver product shipped to another area may be adjusted with the shift amount to 1.16°.

TABLE 1
An exemplary of shift amount table.

| Channel Profile | shift amount δₜ |
|---|---|
| Type 1 | 1.15°/0.02(rad) |
| Type 2 | 2.05°/0.036(rad) |
| Type 3 | 1.75°/0.031(rad) |

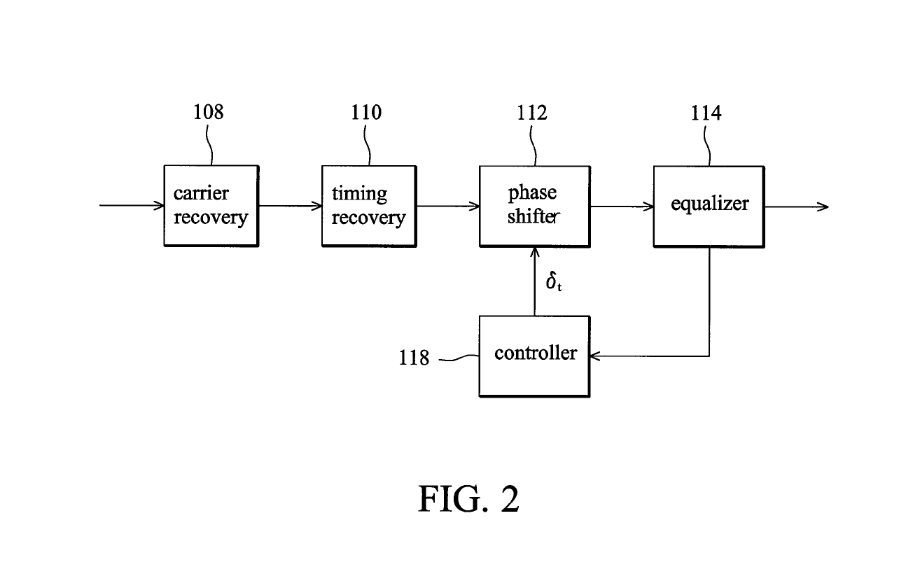

FIG. 2 illustrates a modified variation from FIG. 1. The equalizer 114 delivers an equalization result, and the controller 118 generates a tentative shift amount δₜ according to the equalization result. The equalized result may be analyzed with an equalizer output estimator which analyzes the equalized result and outputs an indicator for indicating what kind of information equalized results provide. The controller 118 adjusts the tentative shift amount δₜ until the equalizer result satisfies a predetermined requirement. For example, the tentative shift amount δₜ is set to zero degrees at the beginning, and the predetermined requirement is that the equalization result has a bit error rate (BER) less than 10⁻⁶. After receiving a first equalization result, 10⁻⁴, the controller 118 shifts the symbol sampling time by

$$+ \frac{M}{360} ° ,$$

and the equalizer 114 produces a second equalization result. If the second equalization result is better than the first equalization result, for example, 10⁻⁵, the controller 118 continues to increase the shift amount δₜ by

$$+ \frac{M}{360} ° ;$$

otherwise, the controller 118 shifts the symbol sampling time by

$$- \frac{M}{360} ° .$$

The tentative shift amount δₜ remains the same until the equalization result achieves the predetermined requirement. The predetermined requirement is not limited to BER, other measurements, such as equalizer convergence, signal-to-noise ratio in the equalization result, and others may be applied as a predetermined requirement.

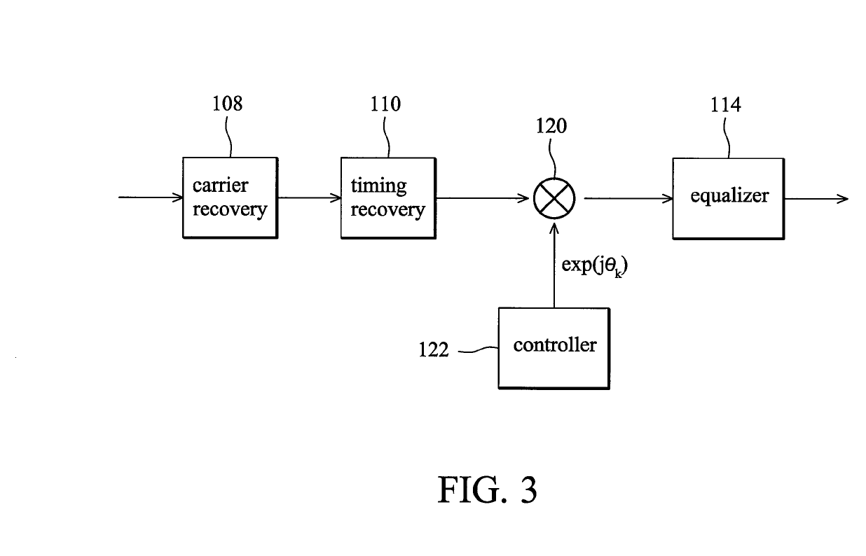

It is not necessary to both adjust timing recovery and carrier recovery even a receiver contains both the carrier recovery device 108 and the timing recovery device 110. FIG. 3 illustrates an example for only adjusting carrier after carrier recovery is applied. The carrier recovery device 108 receives the digitized signal, removes a carrier frequency offset and a phase jitter from the digitized signal to generate a carrier recovered signal. A carrier phase shift unit 120 shifts a carrier phase of the timing recovered signal with a phase shift amount θₖ to generate a carrier phase shifted signal, wherein the carrier phase shift amount θₖ may be positive or negative. A multiplier is an example for implementing the carrier phase shift unit 120. The multiplier multiplies the timing recovered signal with exp(jθₖ) to generate that carrier phase shifted signal. An equalizer 114 applies equalization to the carrier phase shifted signal to remove inter-symbol interference from the carrier phase shifted signal.

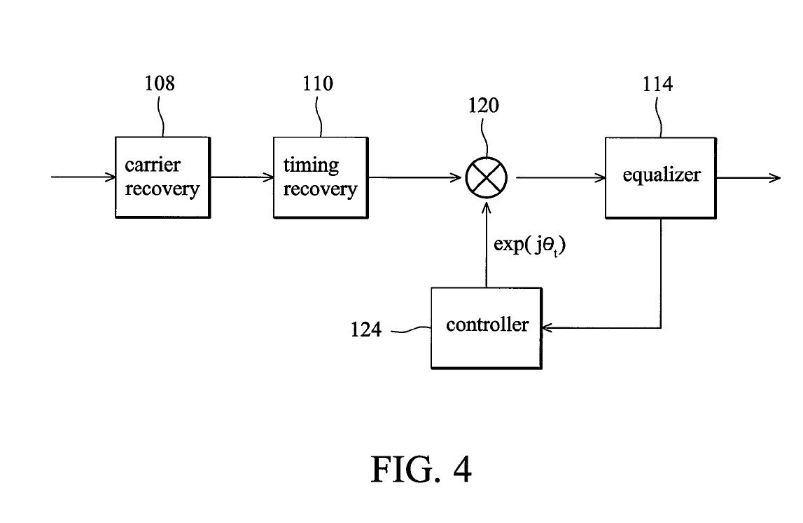

Similarly, the phase shift amount θₖ is determined by a controller 122. The controller 122 may look up a table to determine the carrier phase shift amount θₖ. For example, the default phase shift amount may be 3.05°. A real product may be fine tuned with the phase shift amount to 3.03°, while another product may be adjusted with the phase shift amount to 3.06°. Similarly, FIG. 4 illustrates that the equalizer 114 feedback equalized result to the controller 124. The equalized result may be represented by an indicator with an equalized estimator for helping determine the values of θₜ. For example, the controller 124 adjusts the tentative phase shift amount θₜ until the equalizer result satisfies predetermined condition. Initially, the tentative phase shift amount θₜ may set to zero degrees at the beginning. After receiving a first equalization result, the controller 124 shifts the symbol sampling time by

$$+ \frac{N}{360} ° ,$$

and the equalizer 114 produces a second equalization result. If the second equalization result is better than the first equalization result, the controller 124 continues to increase the phase shift amount

$${θ}_{t} by + \frac{N}{360} ° ;$$

otherwise, the controller 124 shifts the symbol sampling time by

$$- \frac{N}{360} ° .$$

The tentative phase shift amount θₜ is settled until the equalization result achieves a predetermined level.

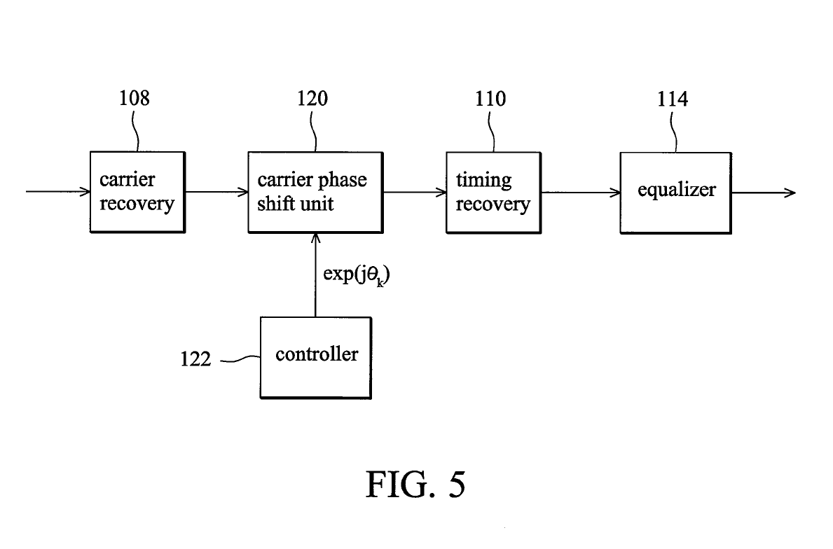

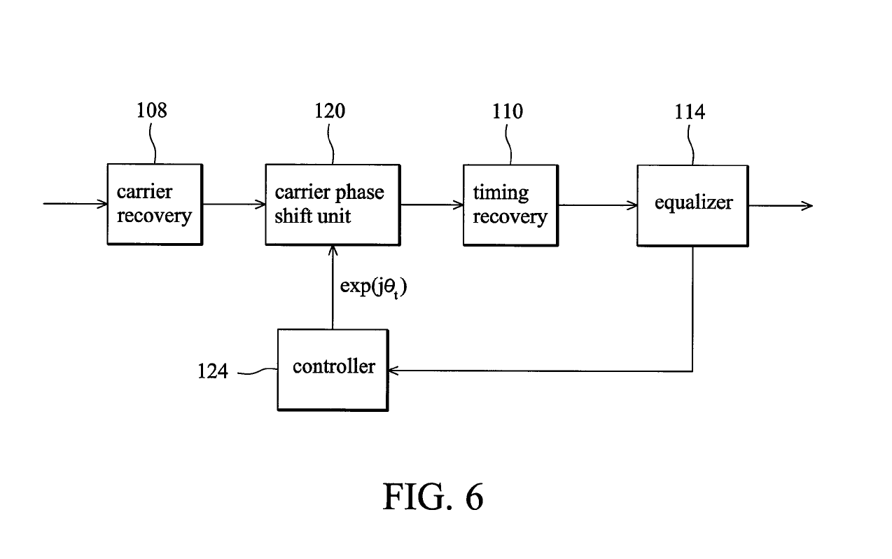

The carrier phase shift and timing recovery operations are independent, thus, whether the carrier phase shift is performed first or the timing recovery is finished first has no effect on the result of the reception apparatus. FIG. 5 and FIG. 6 show examples of performing carrier phase shift prior to timing recovery. Similarly, the phase shift amount θₖ can be determined by a controller 122 looking up a previously built table, or the phase shift amount may also be a tentative result, depending on an equalization result.

Typically, conventional VSB reception apparatuses employ a complex number domain equalizer (complex equalizer), as they are less sensitive to carrier phase offset than a real number domain equalizer (real equalizer). Moreover, conventional VSB reception apparatuses commonly utilize fractional spaced equalizers, as they are less sensitive to symbol sampling timing than symbol spaced equalizers. The described reception apparatus offers a simplified equalizer design, which according to research offers a satisfactory result, even when a symbol spaced, real number domain equalizer is utilized.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A receiver apparatus for processing a received symbol stream that is amplitude-modulated, comprising:
a synchronization module for correcting carrier disorder from the received symbol stream and estimating a re-sampling position of the received symbol stream for generating a compensated symbol stream according to the re-sampling position;
a phase shifter for adjusting the compensated symbol stream with a timing shift amount and a carrier shift amount to generate a shifted symbol stream; and
an equalizer for equalizing the shift symbol stream.

2. The receiver apparatus of claim 1, wherein the timing shift amount and the carrier shift amount are predetermined as constant values.

3. The receiver apparatus of claim 1, further comprising a controller for providing the timing shift amount and the carrier shift amount by analyzing a channel profile of the received symbol stream.

4. The receiver apparatus of claim 3, further comprising:
a channel estimator for estimating a main channel path and at least one cursor channel path for proving the channel profile to the controller.

5. A receiver apparatus for processing a received symbol stream that is amplitude-modulated, comprising:
a timing recovery device for estimating a re-sampling position for the received symbol stream and generating a re-sampled symbol stream according to the re-sampling position;
a timing phase shifter for shifting the re-sampled symbol stream with a timing shift amount to generate a shifted symbol stream; and
an equalizer for equalizing the shifted symbol stream.

6. The receiver apparatus of claim 5, wherein the timing shift amount is predetermined as a constant value.

7. The receiver apparatus of claim 5, further comprising:
a controller for determining the timing shift amount by analyzing a channel profile of the received symbol stream.

8. The receiver apparatus of claim 7, further comprising:
a channel estimator for estimating a main channel path and at least one cursor channel path for providing the channel profile to the controller.

9. The receiver apparatus of claim 7, further comprising:
a storage for storing a mapping table that stores different values of the timing shift amount corresponding to different channel profiles.

10. The receiver apparatus of claim 7, further comprising:
an equalizer output estimator for generating an indicator of equalized result of the equalizer, the indicator being referenced by the controller for determining the timing shift amount.

11. The receiver apparatus of claim 10, wherein the indicator is convergence level of the equalizer.

12. The receiver apparatus of claim 10, wherein the indicator is signal-noise ratio.

13. The receiver apparatus of claim 5, wherein the amplitude-modulated symbol stream is derived from a Vestigial Side Band (VSB) signal.

14. The receiver apparatus of claim 5, wherein the VSB signal is under Advanced Television Systems Committee (ATSC) standard,

15. A receiver apparatus for processing a received symbol stream that is amplitude-modulated, comprising:
a carrier recovery device for correcting carrier disorder from the received symbol stream to generate a carrier recovered stream;
a carrier phase shifter for shifting the carrier recovered stream with a carrier shift amount to generate a shifted symbol stream; and
an equalizer for equalizing the shifted symbol stream.

16. The receiver apparatus of claim 15, wherein the carrier shift amount is predetermined as a constant value.

17. The receiver apparatus of claim 15, further comprising:
a controller for determining the carrier shift amount by analyzing a channel profile of the received symbol stream.

18. The receiver apparatus of claim 17, further comprising:
a channel estimator for estimating a main channel path and at least one cursor channel path for providing the channel profile to the controller.

19. The receiver apparatus of claim 17, further comprising:
a storage for storing a mapping table that stores different values of the carrier shift amount corresponding to different channel profiles.

20. The receiver apparatus of claim 17, further comprising:
an equalizer output estimator for generating an indicator of equalized result of the equalizer, the indicator being referenced by the controller for determining the carrier shift amount.

21. The receiver apparatus of claim 20, wherein the indicator represents a convergence level of the equalizer.

22. The receiver apparatus of claim 20, wherein the indicator represents a signal-noise ratio.
